(19) United States
(12) Patent Application Publication
(10) Pub. No.: US 2010/0127853 A1
(43) Pub. Date: May 27, 2010

(54) METHOD AND APPARATUS FOR LOCATING AND TRACKING OBJECTS IN A MINING ENVIRONMENT

(75) Inventors: James Edward Hanson, Tucson, AZ (US); Jennifer D. Carpenter, Tucson, AZ (US)

Correspondence Address: FENNEMORE CRAIG, P.C., 1700 Lincoln Street, SUITE 2900, DENVER, CO, 80203, US

(73) Assignee: Freeport-McMoRan Copper & Gold Inc., Phoenix, AZ (US)

(21) Appl. No.: 12/276,898

(22) Filed: Nov. 24, 2008

(51) Int. Cl. G08B 1/08

(52) U.S. Cl. 340/539.13

(57) ABSTRACT

Methods and apparatus for locating and tracking objects in a mining environment are disclosed that include selecting an operational area within which the locations of a plurality of objects are to be determined and tracked over time. Radio transceiver systems and associated display systems provided to the plurality objects are operated to form an ad-hoc, peer-to-peer network. The relative positions of the various objects are determined by measuring the time-of-flight of radio signals exchanged between various ones of the radio transceiver systems and analyzing the time-of-flight of such exchanged radio signals. The relative positions of at least some of the objects within the operational area are then displayed on the display system.

### TECHNICAL FIELD

This invention relates to systems and methods for locating and tracking objects in general and more specifically to systems and methods for locating and tracking equipment and personnel in mining operations.

### BACKGROUND

Modern mining operations are highly complex and involve the movement of a large number of machines and personnel within an environment that is constantly changing due to ongoing mining activity. Generally speaking, mine safety and productivity can be improved if the locations and movements of mining equipment and personnel can be accurately ascertained, and numerous systems have been developed in attempts to allow mining equipment and personnel to be located and tracked as they move throughout the mine. However, the potential benefits of such locating and tracking systems are tied the ability of such systems to accurately and reliably track the locations of mine personnel and equipment. Indeed, the failure of such locating and tracking systems to reliably and accurately report the locations of personnel and equipment can be detrimental to mine safety and productivity.

One type of position locating and tracking system that has been proposed for use in mines is an RFID tracking or gating system. Basically, an RFID tracking system uses a plurality of radio-frequency identification or RFID “tags” and “readers” to locate and track personnel and equipment within the mine. In one configuration, several RFID readers are installed at various locations throughout the mine so that they define a plurality of zones or areas between adjacent readers. When an object having a tag closes within range of a reader, the reader detects the tag. The system is able to determine the location of the tag, thus object, based on the particular tag and on the particular reader that detected the tag. By sensing the passage of a tag, the readers thus serve as gates to the various zones, allowing the system to locate and/or track the tag as it moves from reader to reader (i.e., zone to zone).

While RFID tracking systems of the type just described have been proposed for use in mining operations, they are not without their problems. For example, while such tracking systems can track the whereabouts of objects provided with RFID tags by determining whether they have passed through the various gates defined by the RFID readers, such systems cannot provide information about the locations of objects within the zones defined between adjacent gates. If the distance between the gates is substantial, there will be considerable uncertainty as to the exact whereabouts of the object within the zone.

Another problem of RFID locating and tracking systems is that they are prone to erroneous location reporting if the object (e.g., person or vehicle) provided with the RFID tag happens to change direction in the vicinity of the RFID reader or gate. For example, if the object being tracked is traveling in an easterly direction when passing the gate, the system may report the incorrect location of the object if the object happens to change direction (e.g., reverse course) while in the vicinity of the gate. That is, the system may report the position of the object in the zone east of the gate, when the true location of the object will be in the zone west of the gate. Depending on the architecture of the particular RFID system, the position error will not be detected until the object passes another reader.

Another type of locating and tracking system that has been proposed uses a plurality of “position enabled” radio transceivers to provide locating and tracking information of various objects (e.g., equipment and personnel) carrying the radios. The radios are provided with position locating systems that allow the radios to determine their positions based on radio signals from other radio transmitters. For example, many radio-based locating and tracking systems require the use of global positioning system (GPS) signals to obtain and/or derive the required position information. Another type of tracking system derives position information from radio signals produced by other radios in the system, typically by measuring the time required for radio signals to travel between radios.

While such radio-based locating and tracking systems address some of the shortcomings associated with RFID gating-type tracking systems, they are not without their problems. For example, the GPS signals utilized by such systems often cannot be reliably obtained in mining environments, i.e., due to the fact that many mining environments will not allow line-of-sight contact with the number of GPS satellites required for accurate position fixes. In addition, GPS signals are not available underground, making such systems unsuitable for use in underground mines.

Still another problem associated with radio-based systems, particularly so-called “time-of-flight” radio systems, is that they are prone to multi-path radio interference and signal attenuation problems, both of which are exacerbated in mining environments, e.g., due to the presence of large geologic features and heavy mining equipment. In many cases, multi-path interference and signal attenuation problems degrade the performance of the system to the point where it becomes unusable. Still worse, even if the system appears to be functioning well, certain types of multi-path interference may not be detected and can result in false position fixes. That is, the positions of mining equipment and/or personnel will be erroneously reported. Moreover, the problems resulting from multi-path interference and signal attenuation problems are even worse in underground mining environments, again making such systems ill-suited for use in underground mines.

Still yet other problems with radio-based position tracking systems stem from latencies or time delays in determining and reporting the positions of objects within the mine. Such latencies may result from several sources, including signal modulation techniques, packet-based data transmission protocols, and data processing delays. In addition, other factors, such as multi-path interference, signal attenuation, and signal drop-outs, can also increase system latencies. If the latencies become large, they can result in substantial position reporting errors. In many cases, several seconds, or even tens of seconds, may elapse before the system is able to determine the position of a given object. In such instances, the position fix will not be the current position of the object, but rather the position of the object at some time in the past. In extreme cases, the latencies associated with such systems can result in position errors exceeding several tens or perhaps even hundreds of meters, particularly if the object being located is a moving vehicle. Furthermore, the latency problem tends to become worse as additional radios are added to the system, thereby reducing the likelihood that such systems can be successfully deployed in typical mining operations wherein it is desired to track many tens, and typically hundreds, of objects in the mine.

In addition to the issues described above, underground mining operations create additional difficulties in locating and tracking mining equipment and personnel. For example, and as already mentioned, GPS signals are not generally available underground, thereby disqualifying systems that require access to the GPS satellite system in order to provide accurate position fixes. Moreover, most time-of-flight radio systems are not well-suited for use in underground tunnels and drifts due to the signal attenuation and multi-path interference issues created by the tunnels and surrounding geology.

Consequently, the solution to the problem of accurately and reliably locating the positions of personnel and equipment in a mining environment is by no means trivial. The various systems and solutions proposed to date all involve numerous drawbacks and disadvantages that make them less then desirable for use in mining environments.

### SUMMARY OF THE INVENTION

One embodiment of a method for locating and tracking objects in a mine may include: Selecting an operational area in the mine within which the locations of a plurality of objects are to be determined and tracked over time; providing a radio transceiver system to each of the plurality objects operating in the operational area; providing to each of the objects operating in the operational area a display system that is operatively associated with the radio transceiver system; operating the radio transceiver systems to form an ad-hoc, peer-to-peer network; determining the time-of-flight of radio signals exchanged between various ones of the radio transceiver systems; analyzing the time-of-flight of such exchanged radio signals to determine the relative positions of the various objects within the operational area; and displaying the relative positions of at least some of the various objects within the operational area on the display system.

A tracking system according to one embodiment of the invention may include a plurality of objects located within an operational area of a mine within which the locations of the plurality of objects are to be determined and tracked over time. A radio transceiver system operatively associated with individual ones of the plurality of objects includes: rf transceiver means for transmitting and receiving radio signals and processor means operatively associated with the rf transceiver means for determining a time-of-flight required for radio signals to be exchanged between various ones of the plurality of radio transceiver systems and for determining locations of various ones of the plurality of radio transceiver systems based on the time-of-flight of exchanged radio signals. A display system operatively associated with at least some of the plurality of radio transceiver systems is responsive to signals from the radio transceiver systems and displays the relative positions of at least some of the various objects within the mine.

Another disclosed method includes: Selecting an operational area in a mine within which the locations of a plurality of objects are to be determined and tracked over time; providing to each of the objects operating in the operational area a radio transceiver system; providing to each of the objects operating in the operational area a display system that is operatively associated with the radio transceiver system; operating at least one of the radio transceiver systems in a radar mode to determine a relative position of an object within the operational area; and displaying the relative position of the object within the operational area on at least one of the display systems provided to each of the objects.

Another embodiment of a tracking system may include a plurality of objects located within an operational area in a mine within which the locations of the plurality of mine objects are to be determined and tracked over time. A radio transceiver system operatively associated with individual ones of the plurality of mine objects includes: rf transceiver means for transmitting and receiving radio signals and processor means operatively associated with the rf transceiver means for operating said rf transceiver means in a radar mode to determine locations of objects in the operational area by means of radar, and for causing a plurality of said radio transceiver systems to form an ad-hoc, peer-to-peer network. A display system operatively associated with at least some of the plurality of radio transceiver systems is responsive to signals from the radio transceiver system and displays the relative positions of objects located within the operational area.

### BRIEF DESCRIPTION OF THE DRAWINGS

Illustrative and presently preferred exemplary embodiments of the invention are shown in the drawings in which:

FIG. 1 is a schematic overhead topographic view of an open pit mine showing defined operational areas within which objects may be located and tracked by the system of the present invention;

FIG. 2 is an enlarged schematic overhead view of a portion of an operational area illustrated in FIG. 1 showing an example arrangement of objects being tracked;

FIG. 3 is a schematic block diagram of one embodiment of a radio system that may be utilized in conjunction with the present invention;

FIG. 4 is a flow chart of a method for locating and tracking objects according to one embodiment of the invention;

FIG. 5 is a depiction of a situational display that may be provided on a display device associated with the locating and tracking system;

FIG. 6 is a time domain depiction of an ultra-wideband electromagnetic pulse produced by the radio transmitter portion of the radio system;

FIG. 7 is a frequency domain depiction of the ultra-wideband electromagnetic pulse illustrated in FIG. 6;

FIG. 8 is a time domain depiction of an ultra-wideband symbol;

FIG. 9 is a frequency domain depiction of the ultra-wideband symbol illustrated in FIG. 8;

FIG. 10 is a depiction of an operations center and network administrator system that may be utilized in one embodiment of the present invention;

FIG. 11 is a timing diagram illustrating relative timing of sent and received signals from two different radios “A” and “B;”

FIG. 12 is a pictorial representation of a triangulation technique that may be used to locate a position of a radio in two dimensions based on time-of-flight measurements from three other radio systems;

FIG. 13 is a schematic representation of another embodiment of a position and location system as it could be used in an underground mine; and

FIG. 14 is a depiction of a global situational display that may be provided on a display system located at a central operations center.

### DETAILED DESCRIPTION

Various embodiments of a locating and tracking system are shown and described herein as they may be used to locate and track the positions of various objects (e.g., mining equipment and personnel) in various types of mines, including surface mines and underground mines. The locating and tracking system of the present invention solves many of the problems associated with prior art systems and may be used to advantage in a wide variety of mining environments and applications to enhance mine safety and productivity. In addition, various embodiments of the locating and tracking system may be configured so that the system also forms a communications infrastructure capable of transferring large amounts of data at substantial data rates. The ability to provide not only locating and tracking functions, but also ancillary data transfer functions via the communications infrastructure, provides additional utility and the opportunity for further enhanced mine safety and productivity, as described herein.

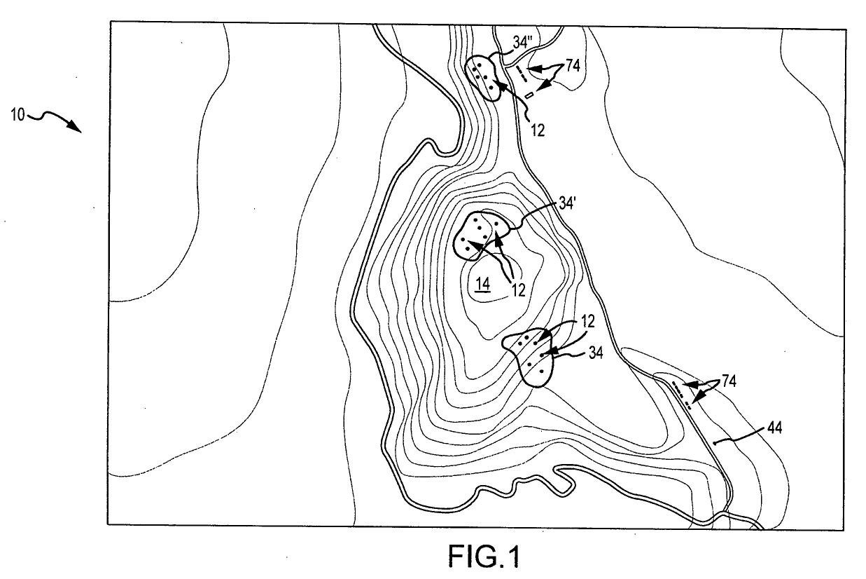

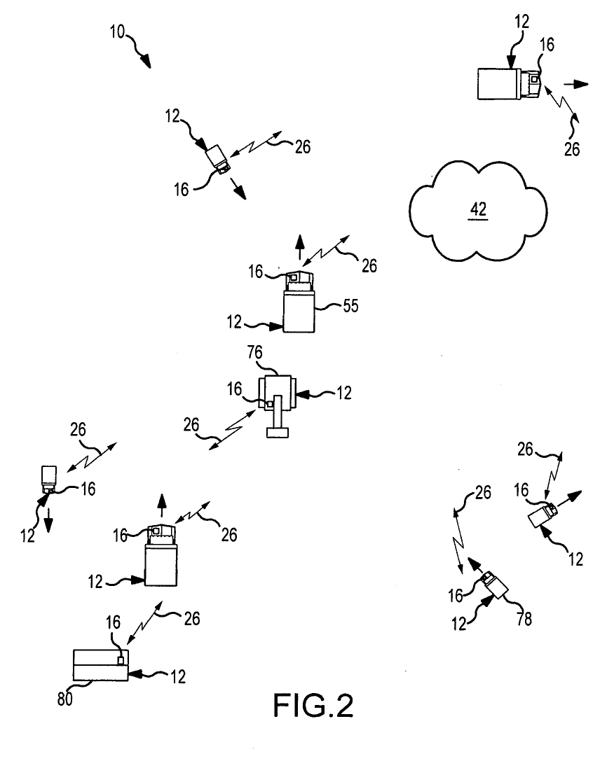

Referring now primarily to FIGS. 1 and 2, one embodiment of a locating and tracking system 10 is shown and described herein as it may be used to locate and track the positions of various objects 12, such as mining equipment and personnel, operating within an open pit mine 14. Briefly described, the tracking system 10 may comprise a plurality of radio transceiver systems 16 that are provided to (or associated with) the various objects 12 that are to be located and tracked. See FIG. 2. For example, if the objects 12 to be tracked comprise mining equipment, each piece of mining equipment is provided with a radio transceiver system 16. Similarly, mining personnel (not illustrated in FIG. 2) may also be provided with portable or hand-held radio systems 16 to allow their positions to be identified and tracked as well, i.e., regardless of whether such personnel remain with the mining equipment being tracked.

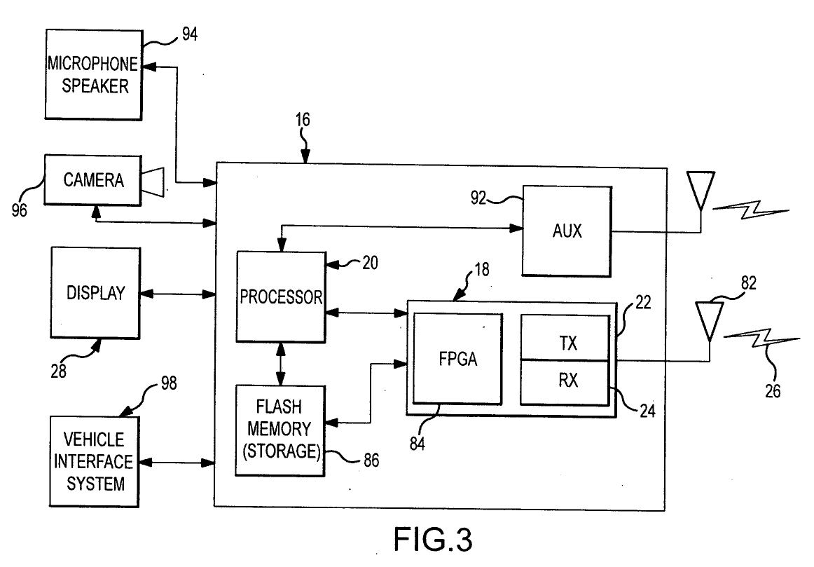

Turning now to FIG. 3, in one embodiment, each radio system 16 may comprise a radio-frequency (rf) transceiver 18 as well as a processor system 20. The rf transceiver 18 may in turn comprise a transmitter section 22 and a receiver section 24, both of which are configured to transmit and receive radio signals 26 in the manner that will be described in more detail herein.

The processor system 20 is operatively associated with the rf transceiver 18 and may be used to control the function and operation of the rf transceiver 18 to transmit and receive radio signals 26. In addition, the processor system 20 may be programmed or configured to perform other functions as well. For example, in one embodiment, the processor system 20 is programmed or configured to determine a time required for radio signals 26 to be exchanged between the “host” radio 16 and various other radios 16. Processor system 20 then determines the location of the “host” radio 16 based on the time-of-flight of the various exchanged radio signals 26. Thus, each radio system 16 is capable of determining its particular position based on the time-of-flight of radio signals 26 received from other radios 16.

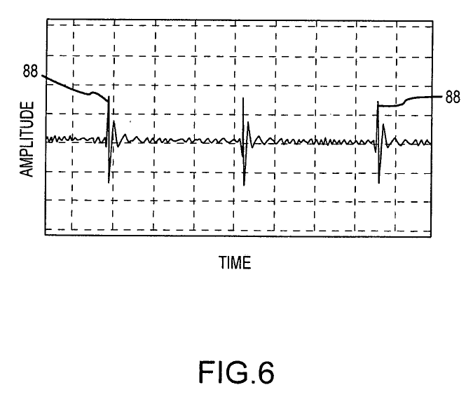

In one embodiment, the radio signals 26 transmitted by the various radio systems 16 comprise ultra-wideband (UWB) radio frequency pulses 88 (FIG. 6) having high intrinsic bandwidths and broad spectral energy distributions. The ultra-wideband (UWB) frequency pulses 88 provide robust wireless operation at extended ranges even in applications operating in high multi-path, non-line-of-sight environments. The ultra-wideband frequency pulses 88 may also be modulated in a way so as to provide the radio system 16 with low latency and high data rate transmission capabilities.

With reference back now to FIG. 3, each radio system 16 may also be provided with a display system 28. The display system 28 may be used to display the relative positions of nearby objects 12 (e.g., mining equipment and personnel), thereby allowing mining equipment operators and personnel observing the display 28 to see at a glance the positions of nearby equipment and personnel (e.g., objects 12). The display system 28 may also be used to present other information that may be useful or beneficial to the various equipment operators and personnel viewing the display 28, as will be described in further detail herein.

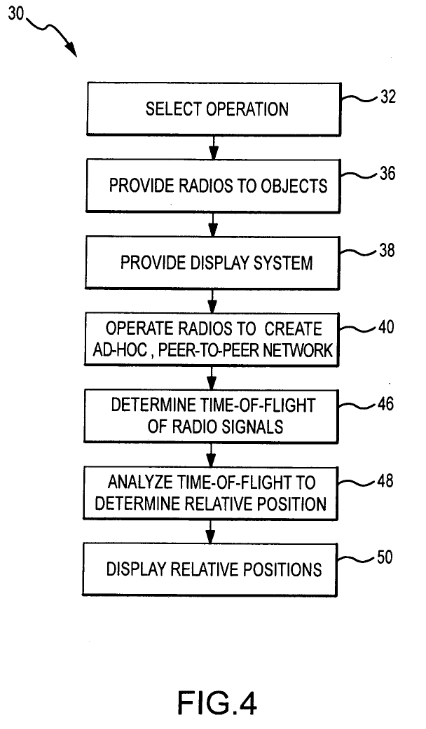

The system 10 may be operated in accordance with a method 30, illustrated in FIG. 4, to locate and track objects 12 in a mining environment 14. A first step 32 in method 30 may involve selecting or defining an operational area 34 in the mine 14 (FIG. 1) within which the locations of the various objects 12 are to be determined and tracked over time. The next steps 36 and 38 in method 30 involve providing at least one radio transceiver system 16 (and associated display system 28) to each of the objects 12 that is to be tracked. See FIG. 2. After each desired object 12 has been provided with a radio transceiver system 16 and display system 28, the various radios 16 may then be operated (e.g., at step 40) so that they form or create an ad-hoc, peer-to-peer network 42 (illustrated schematically in FIG. 2).

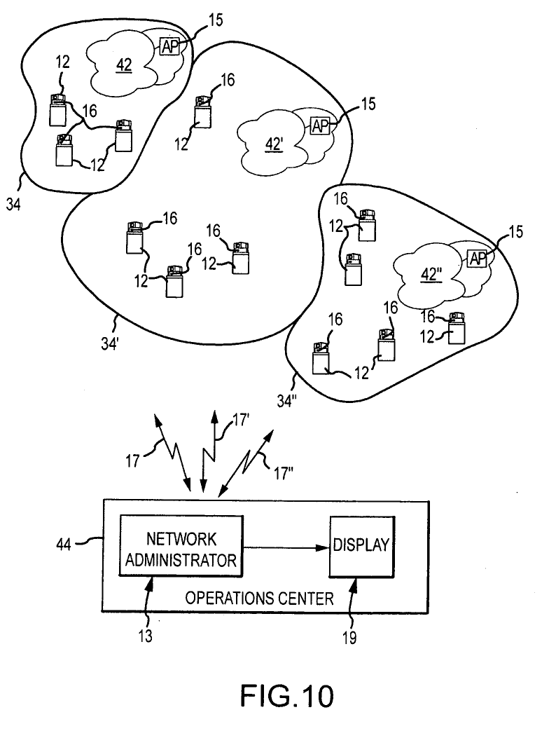

The ad-hoc, peer-to-peer network 42 formed by the various radio systems 16 allows the various radio systems 16 to perform a variety of functions and operations, many of which are described herein and others of which will become apparent to persons having ordinary skill in the art after having become familiar with the teachings provided herein. For example, and as will be described in greater detail below, the ad-hoc, peer-to-peer network 42 provides a convenient means for implementing one or more time-of-flight position location algorithms to allow the locations of various ones of the radio systems 16 to be determined with a great deal of accuracy (e.g., in the centimeter range), and without requiring access to the Global Positioning System. The network 42 also provides a wireless communications infrastructure that allows other types of data to be transmitted to the various other radio systems 16 and/or to a central operations center 44. See FIGS. 1 and 10.

Continuing now with the description of the method 30 illustrated in FIG. 4, step 46 involves operating some or all of the various radio systems 16 to determine the time required for radio signals 26 (e.g., illustrated in FIG. 2) to be exchanged between various ones of the radio systems 16 in network 42. The time-of-flight of such radio signals 26 is then analyzed at step 48 to determine the relative positions of the various radio systems 16, thus objects 12, within the operational area 34. Step 50 involves displaying on display system 28 the relative positions of at least some of the objects 12 within the operational area 34.

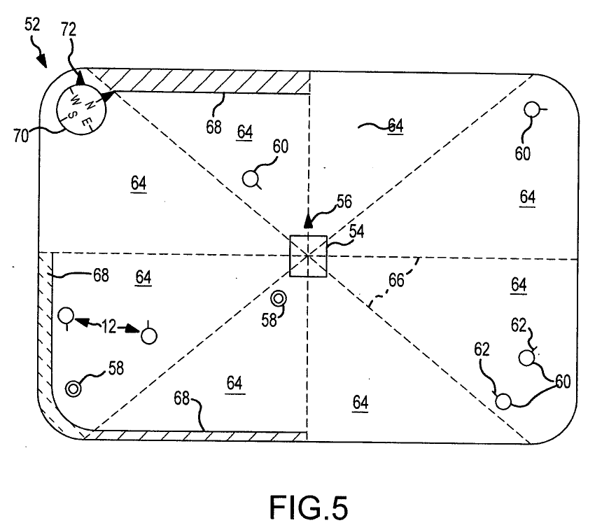

An example of relative position data that may be provided on display system 28 is illustrated in FIG. 5. Briefly, situational display 52 shows the locations of nearby objects 12 (in this example, the objects 12 illustrated in FIG. 2). In one embodiment, the particular object 12 carrying radio system 16 may be displayed at the center of the situational display 52 as a “self” or “own equipment” icon 54. In this example, the “self” or “own equipment” icon 54 corresponds to the haul truck 55 illustrated in FIG. 2. Accordingly, an operator (not shown) viewing the situational display 52 associated with his particular vehicle or person will see his vehicle or person (as the case may be) displayed at the center of the situational display 52 as the “self” or “own equipment” icon 54. The particular object located at the center of the situational display 52 may be referred to herein in the alternate as the “center” object 12 to distinguish it from “surrounding” objects 12.

In the particular operational scenario illustrated in FIG. 5, the center object 12 comprises the haul truck 55 (e.g., illustrated in FIG. 2) and is represented by icon 54 located at the center of the situational display 52 in the manner just described. If the “center” object is moving, the direction of motion of the center object (i.e., represented by icon 54) may be indicated by an arrow icon 56 located adjacent icon 54. In one embodiment, the direction of motion (and velocity) of each object 12 may be determined by analyzing the change in position data over time of each such object 12. “Surrounding” objects 12 located nearby center object 12 (e.g., haul truck 55) may be represented with different icons depending on whether they are moving or stationary. For example, in the particular operational scenario illustrated in FIG. 5, stationary objects are represented by ring icons 58, whereas objects in motion are represented by solid circle icons 60. Alternatively, icons having other shapes and configurations may be used to designate moving and stationary objects 12. The moving objects 12, i.e., those represented by solid circle icons 60, also may be provided with pointers or line segments 62 that indicate the direction of movement of the respective moving objects 12.

The various icons presented on situational display 52 may be displayed in certain colors or with other identifying indicia depending on whether they are located within certain predetermined distances from the “center” object 12 (i.e., haul truck 55, represented by icon 54). For example, surrounding objects 12 that are located nearby center object 12 may be displayed in a color red, thereby indicating to the operator that such objects are close and may pose collision or other hazards. Surrounding objects 12 located at greater distances (e.g., where they would not pose an immediate collision or other hazard) may be displayed in a color green. That is, objects 12 that are displayed in a green color indicate to the vehicle operator that they are located a safe distance away. Surrounding objects 12 located at intermediate distances (i.e., between a “red” or “close” distance and a “green” or “safe” distance), from the center object 12 may be displayed in a color yellow.

The situational display 52 may be also include other features and icons to convey additional information to the user or vehicle operator, as the case may be. For example, in the particular operational scenario illustrated in FIG. 5, the situational display 52 is divided into a plurality of regions (e.g., octants 64), each of which may be defined by broken lines 66. In one embodiment, broken lines 66 may also be shown on situational display 52, although this need not be the case. Moreover, each octant 64 may be provided with an “alert bar” or icon 68 that may be caused to appear on the situational display 52 when one or more objects 12 in the octant 64 is located within the predetermined distances just described.

The alert bars 68 may be displayed in the same color as that of the objects 12 that are located within the corresponding predetermined distance. For example, the alert icon 68 may be displayed in a color yellow if one or more objects 12 in the corresponding octant 64 are located in the “yellow” distance range from the center object 12 (i.e., represented by “self” icon 54). The alert bar 68 may be displayed in a color red if one or more of the objects 12 in the corresponding octant 64 are located in the “red” distance range from the center object 12.

Situational display 52 may also be provided with other icons or information that may be helpful to a person observing the situational display 52. For example, in the embodiment shown and described herein, situational display 52 may be provided with a compass rose icon 70. A heading “bug” or indicator 72 may be displayed adjacent compass rose 70 to indicate the current heading of the center object 12, in this scenario, haul truck 55 (i.e., represented by “own equipment” icon 54 in FIG. 5). In one embodiment, the heading of each object 12 may be determined by analyzing the change in position data over time of each such object 12.

In addition to showing the situational display 52, the display system 28 of radio system 16 may also be operated in other modes to provide additional information to the user or vehicle operator. For example, display system 28 may be used to display video, graphic, or text information that may be of interest to the user or vehicle operator, as will be described in further detail below.

The situational display 52 just described may be displayed on the display systems 28 associated with each of the radio systems 16, thereby allowing mine personnel, such as equipment operators, to immediately ascertain, at a glance, the operational situation in the immediately surrounding area. In addition, the position data from the various individual displays 28 may also be collected, integrated, and displayed on a display system 19 located at the central operations center 44, as best seen in FIG. 10.

A significant advantage of the present invention is that it provides a means for locating and tracking personnel and equipment in a mining environment and for providing that information (e.g., via the display system 28) to each person or equipment operator. Accordingly, each such person or operator can readily ascertain the operational situation in the surrounding area. Moreover, the location and tracking information can also be provided to a central operations center 44 (FIG. 10) to allow mine managers and others to monitor the current operational situation in the mine.

Still yet other advantages are associated with the situational display 52 (FIG. 5). For example, besides showing the locations of objects in the immediately surrounding area, the situational display 52 may also indicate whether those objects are moving or stationary. Moreover, the direction in which the moving objects 12 are traveling may also presented on the situational display 52, thereby allowing operators to identify and avoid objects 12 that may pose collision risks.

Additional utility is provided by the alert bar icons, which may be activated or illuminated in those regions (e.g., octants 64) that contain objects 12 within certain predetermined distances from the “center” object 12. Yellow and red alert bar icons 68 may be utilized to provide a warning to the operator as the distance closes between the center object 12 and the surrounding objects 12. In addition, the system 10 may provide an aural (i.e., sound) warning to ensure that an operator is aware of such nearby objects. Additional safety against collisions may be provided by connecting the system 10 to the control system of the associated vehicle. The system 10 could then be configured to automatically stop the vehicle, i.e., without driver input, if the system 10 determines that a collision is imminent.

Other substantial advantages are associated with the ultra-wideband radio frequency pulses 88 and modulation techniques that are utilized by the radio systems 16. For example, the ultra-wideband radio pulses 88 and modulation techniques provide substantially increased immunity to multi-path interference and signal attenuation due to non-line-of-sight positioning compared to conventional, narrow-band radio systems using conventional modulation techniques. As a result, the use of ultra-wideband radio frequency pulses 88 substantially reduces problems associated with multi-path interference and signal attenuation or signal dropout events, thereby substantially increasing the likelihood that the system 10 can be successfully deployed in nearly all types of mining environments, including open pit mines and underground mines.

The ultra-wideband radio pulses transmitted by the radio systems 16 also allow the transceiver 18 to be operated in a radar mode, which can provide additional advantages and benefits with respect to obstacle detection and avoidance. For example, when operated in the radar mode, the radio system 16 may be used to detect the presence of berms, high-walls, or other obstacles that may not be provided with a radio system, but that nevertheless could pose a collision or other hazard. The radar mode of operation could be used to considerable advantage in adverse weather conditions, such as fog, rain, or snow, where visibility is substantially reduced.

Still other advantages stemming from the ultra-wideband radio pulses 88 is that they provide a high bandwidth. The high bandwidth allows for extremely high data transfer rates, which can be used to significant advantage in reducing system latencies.

In addition, the high data transfer rates that are possible with the high bandwidths provided by the ultra-wideband radio pulses means that the radio systems 16 also may be used to form a communications infrastructure that is capable of transferring large amounts of data at substantial data rates. Significantly, the communications infrastructure is in addition to the position locating and tracking functions that may be provided by the system 10. That is, the same system 10 that provides locating and tracking information for objects 12 in the mining area may also provide a communications infrastructure to allow other types of information to be transferred via the network 42 formed by the various radio systems 16. For example, the communications infrastructure may be used to transfer sound and/or video data, thereby allowing mining personnel to see and hear information from any one of the various operators, such as, for example, to see a video depiction of a piece of equipment in operation. The communications infrastructure can also be used to transmit data relating to certain operating characteristics (i.e., “machine health”) of mining equipment provided with the radio systems 16. The communications infrastructure also supports conventional voice communications.

Still yet other information can be transmitted by system 10 via the communications infrastructure formed by the ad-hoc, peer-to-peer network 42. For example, updated maps of the mine could be transferred over the network 42 and caused to appear on the display system 28, thereby allowing personnel to view the updated maps and be informed of changes or closures of certain areas of the mine.

The communications infrastructure may be of substantial benefit in the event miners become trapped underground. Besides the fact that rescue personnel will know exactly where such mining personnel are trapped (i.e., by virtue of the substantially continuous position fixes provided by the system 10), the trapped miners may also be able to communicate to the rescue personnel via the radio system 16 because of the ultra-wideband radio transmission system. That is, the ultra-wideband transmission system will be capable of successfully transmitting data in situations that would be impossible with conventional, narrow-band systems.

Having briefly described one embodiment of a locating and tracking system according to the present invention, as well as some of its more significant features and advantages, various exemplary embodiments and operational modes of the locating and tracking system will now be described in more detail. However, before proceeding with the description it should be noted that while the various exemplary embodiments and operational modes of the system 10 are shown and described herein as they could be utilized in certain open pit and underground mining environments, applications, and operational scenarios, the present invention may also be used in any of a wide variety of other types of mining environments, applications and operational scenarios, as would become apparent to persons having ordinary skill in the art after having become familiar with the teachings provided herein. Consequently, the present invention should not be regarded as limited to the particular environments, applications, and operational scenarios shown and described herein.

Referring back now to FIGS. 1 and 2, one embodiment of a locating and tracking system 10 according to the present invention is shown and described herein as it could be used to locate and track the positions of various objects 12 within one or more defined operational areas 34, 34′, and 34″ of an open pit mine 14. An operational area 34, 34″, 34″ of a mine 14 defines that region within which objects 12, such as mining equipment and personnel, are to be located and tracked by the system 10. The operational areas 34, 34′, 34″ encompass certain limited or defined portions of the mine 14 and need not include other areas of the mine, such as inactive or closed areas, administrative offices 74 and the like, wherein it is not desired to locate and track objects.

The provision of one or more defined operational areas 34, 34′, 34″ may be used to advantage in configuring and operating the locating and tracking system 10. For example, each defined operational area 34, 34′, 34″ may be used to impose a limit (i.e., due to the defined size of the operational areas 34, 34′, 34″) on the number of radios 16 that are located within a defined operational area at any given time, thereby reducing the possibility that an excessive number of radios 16 will lead to network congestion, increased latencies, or other problems. Stated simply, the use of the defined operational areas (e.g., 34, 34′, and 34″) allows radio systems 16 located within a first operational area (e.g., operational area 34) to ignore transmissions from radio systems 16 located in other operational areas (e.g., operational areas 34′ and 34″). Likewise, radio systems 16 located in such other operational areas (e.g., 34′ and 34″) may ignore transmissions from radio systems 16 located in the first operational area (e.g., 34).

However, and as will be described in greater detail below, the position and location information derived from radio systems 16 located in the various defined operational areas 34, 34′ and 34″ are nevertheless available to the system 10 and may be collected, integrated, or further processed by the system 10 to allow such information to be displayed or otherwise made available to operations managers or personnel located at the central operations center 44 (FIG. 10). In addition, other functions, such as the communication of supplemental data, may be exchanged among the various radio systems 16 regardless of the operational area 34, 34′, 34″ within which they are located.

The operational area(s) 34, 34′, 34″ may comprise any of a wide range of sizes, shapes, and configurations depending on the particular mining operation and other factors that would become apparent to persons having ordinary skill in the art after having become familiar with the teachings provided herein. For example, while the various operational areas 34, 34′, and 34″ illustrated in FIG. 1 have generally irregular shapes, their illustration in FIG. 1 is notional only, and does not necessarily correspond to the sizes, shapes, and configurations of the operational areas might actually exist in a particular mine 14. In many cases, it may be desirable to define the operational areas 34, 34′, and 34″ so that they have regular, geometric shapes (e.g., square, rectangular, circular, etc.), as it will be generally easier to define the boundaries of the operational areas. Also, while the various operational areas 34, 34′, and 34″ are illustrated in FIG. 1 as separate, non-contiguous areas, they may be arranged or configured so that one or more of the operational areas 34, 34′, 34″ are contiguous, as illustrated in FIG. 10. The sizes and shapes of the operational areas 34, 34′, and 34″ may also change over time as the mining environment changes due to continuing operations. That is, the sizes and shapes of the operational areas 34, 34′, 34″ need not be fixed over time.

In any event, and regardless of the number, size, shape, and configuration of the various defined operational areas 34, 34′ and 34,″ tracking system 10 may comprise a plurality of radio systems 16 that are provided to, or associated with, the various objects 12 that are to be located and tracked in the defined operational areas (e.g., 34, 34′, 34″). For example, and referring now primarily to FIG. 2, if the object 12 to be tracked comprises a piece of mining equipment, such as a haul truck 55, a shovel 76, or a service vehicle 78, each such piece of mining equipment should be provided with a radio system 16. Stationary objects, such as a building 80, may also be provided with a radio system 16, although the locations of such stationary objects could be programmed into the system 10 instead. So providing each piece of mining equipment with at least one radio system 16 will allow the system 10 to locate and track the mining equipment as it moves within the operational area 34. The system 10 will also be able to locate and track the piece of mining equipment as it moves between and among various other operational areas 34, 34′ and 34″ in the manner that will be described in further detail below.

Mining personnel that are expected to travel on foot within the defined operational area(s) 34, 34′, 34″ may also be provided with portable or “hand-held” versions of the radio systems 16 that are sized to be readily carried by such personnel. While not specifically shown herein, a portable or hand-held version of the radio system 16 could be similar in size and shape to a cellular telephone or personal digital assistant. The display system 28 of such a portable or hand-held version could comprise an integral portion of the radio system 16, also in a manner akin to a cellular telephone or personal digital assistant.

Referring now primarily to FIG. 3, and regardless of its particular physical package or configuration, each radio system 16 may comprise a radio-frequency (rf) transceiver 18 and a processor system 20 suitable for transmitting, receiving, and processing radio signals 24 in the manner described herein. In addition, radio system 16 may be provided with any of a wide range of ancillary systems and devices (not shown), such as battery systems, user interface systems (e.g., keypads or touch screens), wired or wireless ethernet ports, etc., that may be required or desired in any given application. However, because such ancillary systems are well known in the art and could be readily provided by persons having ordinary skill in the art after having become familiar with the teachings provided herein, the particular ancillary systems and devices that may be utilized in the radio system 16 will not be described in further detail herein.

The radio transceiver 18 may comprise a transmitter section 22 and a receiver section 24, both of which are operatively associated with an antenna system 82. Radio transceiver 18 may also comprise a field programmable gate array (FPGA) 84 that may be programmed or configured to control the function and operation of the transmitter and receiver sections 22 and 24 of transceiver 18. Alternatively, other types of devices, such as general purpose programmable processors or application-specific integrated circuits (ASICs) could be used to control the function and operation of the transmitter and receiver sections 22 and 24 of transceiver 18.

The radio transceiver 18 (i.e., comprising transmitter and receiver sections 22 and 24) may comprise any of a wide range of radio transceiver systems that are now known in the art or that may be developed in the future that would be suitable for the intended application. While not required, it is generally preferred that the radio transceiver 18 comprise an ultra-wideband transceiver 18, as opposed to a narrow band transceiver. As described herein, the use of ultra-wideband radio frequency transmission provides the system 10 with significant advantages compared to narrow band transceiver systems. By way of example, in one embodiment, the radio transceiver 18, i.e., comprising the transmitter and receiver sections 22 and 24, comprises an “Aspen” radio chip set available from General Atomics Corporation of San Diego, Calif., as model no. 2000-006.

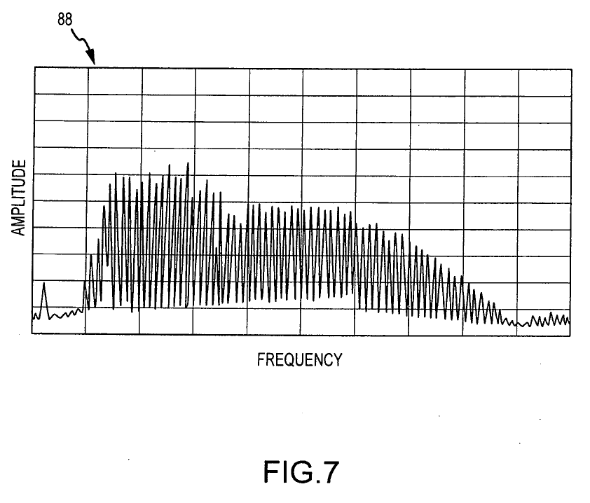

Briefly described, and with reference primarily to FIGS. 6 and 7, the Aspen radio chipset comprises an ultra-wideband radio transceiver 18 that transmits and receives ultra-wideband (UWB) radio signals 26. More specifically, the transmitter section 22 of transceiver system 18 produces a series of ultra-wideband electromagnetic pulses 88, as best seen in FIG. 6. While the electromagnetic pulses 88 appear to be narrow when depicted in the time domain, as illustrated in FIG. 6, each ultra-wideband (UWB) pulse 88 has a high intrinsic bandwidth and broad spectral energy distribution, as illustrated in FIG. 7, which depicts one of the UWB pulses 88 in the frequency domain. Stated simply, each UWB pulse 88 comprises a wide range of frequencies. In one embodiment, each electromagnetic pulse 88 may have a duration in the range of about 100 picoseconds (ps) to about 5 nanoseconds (ns) and comprises a fractional bandwidth that is at least about 20% of the center frequency of the UWB pulse 88.

The Aspen radio chipset comprising the radio transceiver system 18 may be configured or programmed to modulate the UWB pulses 88 in accordance with a modulation technique known as “Spectral Keying,” which is a registered trademark of General Atomics Corporation. The details of the Spectral Keying modulation technique are described in detail in U.S. Pat. No. 6,895,059, entitled “Method and Apparatus for Data Transfer Using a Time Division Multiple Frequency Scheme” which is specifically incorporated herein by reference for all that it discloses.

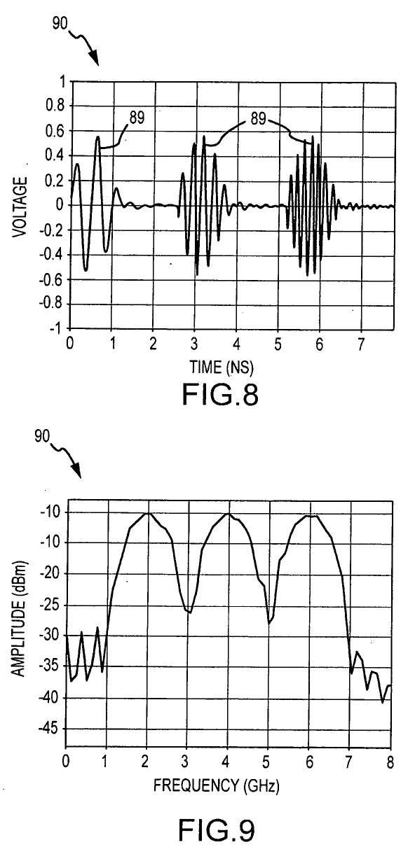

Briefly, and with reference now to FIGS. 8 and 9, the Spectral Keying modulation technique utilizes the frequency content of the pulses 88 to convey or transmit information. The information to be transmitted is encoded through the time-dependency of the various frequency components within the UWB pulse 88. In effect, each UWB pulse 88 comprises a sequence of smaller pulses or subpulses 89, each of which is centered on a different frequency, as best seen in FIGS. 8 and 9. The order of the frequencies of the subpulses 89 comprising each pulse 88 may be used to define a symbol 90. FIG. 8 depicts the symbol 90 in the time domain, whereas FIG. 9 depicts the symbol 90 in the frequency domain.

The number of symbols 90 that can be defined for a given number of frequency bands (i.e., subpulses 89 centered on different frequencies) is the factorial of the number of frequency bands. For example, three frequency bands will allow 3! (i.e., 6) symbols 90 to be used to transmit information. Five frequency bands will allow 5! (i.e., 120) symbols 90 to be used to transmit data, whereas the use of 6 frequency bands would allow 6! (i.e., 720) symbols 90 to be used. In the embodiment illustrated in FIGS. 8 and 9, subpulses 89 used to define the symbols 90 are centered on three different frequencies of about 3.48, 4.02, 4.56 gigahertz (GHz). However, in another embodiment, the subpulses 89 are centered on five different frequencies, e.g., at about 3.48, 4.02, 4.56, 6.12, and 6.96 GHz, which will allow 120 symbols to be used to transmit data.

The high data density resulting from the Spectral Keying modulation technique just described substantially increases the resistance of the system to multi-path interference. Increasing the data sent in each symbol reduces the number of symbols that must be sent. As a result, the time between symbols can be large, which reduces inter-symbol interference that would otherwise result from multi-path interference.

Referring back now primarily to FIG. 3, each radio system 16 may also be provided with a processor 20 and a memory system 86. As mentioned above, processor 20 may be used to control the function and operation of the rf transceiver system 18 as well as to process data received from the transceiver system 18. For example, in one embodiment, processor 20 processes radio signal data from the rf transceiver system 18 to determine the time-of-flight of radio signals 26 exchanged between various ones of the radios 16. Processor 20 then uses the time-of-flight data to calculate or determine the positions of the various radios 16.

Processor system 20 may also be used to process other data received by the rf transceiver 18. For example, processor system 20 may be programmed to analyze position data associated with various objects 12 as such data change over time in order to determine the heading or direction of travel of the corresponding objects 12. The change of position data over time may also be used to determine the headings of objects 12 as well as their velocities. Processor 20 may also use the position data of each object 12 to generate a network identifier tag 27 in the manner that will be described in greater detail below. Processor system 20 may also interface with the memory system 86 to store data.

Processor system 20 may comprise any of a wide range of general purpose programmable processors that are now known in the art or that may be developed in the future that would be suitable for the intended application. Consequently, processor system 20 should not be regarded as limited to any particular type of processor. Alternatively, other types of processors, such as application-specific integrated circuits, could also be used. Likewise, memory system 86 may comprise any of a wide range of memory systems that are now known in the art or that may be developed in the future that would be suitable for the intended application. By way of example, in one embodiment, memory system 86 may comprise a flash memory system of the type that is well-known in the art and readily commercially available.

In the embodiment illustrated in FIG. 3, radio system 16 may also be provided with an auxiliary radio transceiver 92. Auxiliary radio transceiver 92 may be operatively associated with processor system 20 and may be used to transmit auxiliary data and information not transmitted by the transceiver 18. Auxiliary radio transceiver 92 may also be used as a back-up radio system. Depending on the nature of the auxiliary data that are to be transmitted and/or whether auxiliary radio transceiver 92 is to be used as a back-up system, the auxiliary radio transceiver 92 may comprise an ultra-wideband radio transmitter of the type already described for the radio transceiver 18. Alternatively, the auxiliary radio transceiver 92 may comprise a narrowband transmitter of the type that is well-known in the art and readily commercially available.

Still referring primarily to FIG. 3, each radio system 16 may also be provided with additional systems and devices to provide increased functionality to the radio system 16. For example, radio system 16 may be provided with a microphone/speaker system 94 to allow voice communications between the various radios 16 and to provide various aural (i.e., sound) warning signals to the operator. Radio system 16 may also be provided with a camera system 96 to allow still photographs and/or video to be captured by the radio system 16. Such visual data may then be transmitted (e.g., via network 42) to other radio systems 16 and/or the central operations center 44. The various additional systems and devices may be operatively associated with radio system 16 via conventional wired interfaces, infrared interfaces, or wireless interfaces. However, because such additional systems and devices, e.g., such as microphone/speaker system 94 and camera system 96, as well as systems for operatively connecting them to radio 16 are well-known in the art and could be easily provided by persons having ordinary skill in the art after having become familiar with the teachings provided, the particular microphone/speaker system 94 and camera system 96 that may be utilized in one embodiment of the present invention will not be described in further detail herein.

Each radio system 16 may also be provided with a display system 28 to allow various information and data collected by the radio system 16 to be presented in visual form to the user. The particular type of display system 28 may vary depending on the intended application of the radio system 16. For example, if the radio system 16 is to be carried by mine personnel, i.e., where the radio system 16 comprises a portable, hand-held unit, then display system 28 may comprise a small LCD display of the type commonly used in portable cellular telephones and personal digital assistants. The display system 28 in such an application may comprise an integral portion of the radio system 16. In another configuration, i.e., where the radio system 16 is configured to be installed in a piece of mining equipment or a vehicle, display system 28 could comprise a larger LCD display. The display may also be “hardened” e.g., provided in a shock- and weather-resistant housing, to provide increased reliability and resistance to the mining environment.

In accordance with the foregoing considerations, then, display system 28 may comprise any of a wide range of display systems and devices that are now known in the art or that may be available in the future that would be suitable for the intended application. Consequently, the present invention should not be regarded as limited to use with any particular type of display system 28.

In an application wherein the radio system 16 is to be installed in a piece of mining equipment, radio system 16 may also be provided with a vehicle interface system 98. Vehicle interface system 98 will allow the radio system 16 to send commands (e.g., via the vehicle interface system 98) to the associated vehicle under certain conditions. For example, in one embodiment, the radio system 16 could issue commands that will be used by the vehicle interface system 98 to automatically stop the vehicle if continued movement of the vehicle could result in a collision or other unsafe condition.

Vehicle interface systems 98 of the type that may be utilized herein are well-known in the art and could be readily provided by persons having ordinary skill in the art after becoming familiar with the teachings provided herein and after considering the particular type of equipment or vehicle on which such an interface system 98 will be used. Consequently, the particular vehicle interface system 98 that may be used in one embodiment of the invention will not be described in further detail herein.

The system 10 may also be provided with other devices and systems to provide increased functionality and capability in certain situations. For example, in the embodiment shown and described herein, the system 10 may also comprise a central operations center 44 (FIGS. 1 and 10), which may be situated at a remote location to allow operations managers to monitor and/or manage the mining operation as well as the deployment of mining equipment and personnel.

Referring now specifically to FIG. 10, the operations center 44 may be provided with a network administrator system 13 that communicates with the various ad-hoc, peer-to-peer networks 42, 42′, 42″ that are formed or created by the various radios 16 located in the various operational areas 34, 34′, 34″. The network administrator system 13 may communicate with the various networks 42, 42′, and 42″ via corresponding network access points 15 and communications links 17. The operations center 44 may also be provided with one or more display systems 19 that are operatively associated with network administrator system 13. An operations manager (not shown) may operate the network administrator 13 and display system 19 to cause any of a wide variety of information to be displayed. For example, the operations manager may command the system 10 to display a duplicate of the situational display 52 that is currently being displayed on any desired radio system 16 in any desired operational area 34.

Other information may be displayed on display system 19, as would become apparent to persons having ordinary skill in the art after having become familiar with the teachings provided herein. For example, in another scenario, the operations manager could instruct a particular vehicle operator to turn-on or otherwise activate the camera system 96 associated with the radio 16. The operations manager could then operate the network administrator system 13 to cause video data from the camera system 96 to appear on display system 19. The operations manager could then observe any desired area, vehicle, or operation in real time.

The ability to transmit photos and/or video data in real time to the operations center 44 could also be of assistance in troubleshooting equipment problems or repairing disabled equipment. For example, an equipment expert or mechanic located at the operations center 44 could view the malfunctioning and/or disabled equipment and dispatch the necessary personnel and/or replacement parts to the particular location. In addition, radio systems 16 provided on vehicles could transmit to the operations center 44 certain information about the vehicle (e.g., “machine health” data), via the vehicle interface system 98. Still other types information can be exchanged between the operations center 44 and any or all of the radio systems 16. For example, updated mine maps or other information about current mine operations could be transmitted over the system 10. Other information of benefit to personnel operating in the mine, such as scheduled blasting times and/or equipment servicing needs could also be transmitted on a real-time basis or as the need arises.

Referring back now to FIG. 4, the system 10 may be operated in accordance with a method 30 to locate and track objects 12 in a mining environment. A first step 32 of method 30 may involve selecting or defining an operational area 34 in the mine 14 within which the locations of the various objects 12 are to be determined and tracked over time. As discussed above, one or more operational areas (e.g., 34, 34′, 34′) may be defined depending on any of a wide variety of considerations. For example, the operational areas (e.g., 34, 34′, 34″) may be selected or defined so as to exclude certain areas in the mine wherein it is not desired to locate or track objects 12. Such areas may include, for example, administrative offices and support buildings 74 (FIG. 1). Certain other areas of the mine may be closed to operations or otherwise inactive, and it may be desirable in certain situations to exclude those areas from the operational area(s) as well.

The careful selection of the operational area(s) (e.g., 34, 34′, 34″) may also be used to reduce the likelihood of creating excessive amounts of network congestion and/or system latencies. For example, in the example embodiments shown and described herein, the radio systems 16 within each operational area (e.g., 34, 34′, and 34″) form respective ad-hoc peer-to-peer networks 42, 42′, 42″ (FIG. 10). Accordingly, the “size” (i.e., the logical size, not necessarily the physical size) of each network 42, 42′, 42″ is related to the “size” of each operational area, i.e., as defined by the number of radio systems 16 that are present in the operational area 34 at any given time. See FIGS. 1 and 10. Consequently, each operational area 34 may be configured so as to divide the mine area 14 into smaller portions that, by virtue of the limited sizes of the various operational areas 34, 34′ and 34,″ will effectively limit the number of radio systems 16 that will comprise the ad-hoc, peer-to-peer network 42 within the operational area 34. Consequently, the networks 42, 42′, 42″ that correspond to the operational areas 34, 34′ and 34″ will, in effect, be “subnetworks” that need only interface with the other “subnetworks” on a limited basis. In this manner, then, careful design of the operational areas 34, 34′, 34″ may be used as a network management tool to limit the sizes of the various networks 42, 42′, 42″ to ensure optimal performance within each network.

Besides being used as a network management tool, the operational areas 34, 34′, and 34″ may also be configured to follow certain physical boundaries or operational zones within the mine. For example, a given operational area 34 may be shaped or configured to correspond to the physical boundaries of a haul road (or drift, in the example of an underground mine), because the haul road (or drift) defines those areas within which other objects 12 will be located and tracked. The operational area 34 may also be configured to exclude, for example, high walls and other obstructions, wherein objects 12 are not expected to operate. In this manner, then, several operational areas 34, 34′, 34″ may be defined adjacent one another so that objects 12 moving from operational area to operational area will be tracked by the particular network (e.g., 42, 42′, 42″) associated with each operational area.

With reference back now to FIG. 4, method 30 may next involve providing at least one radio system 16 and associated display system 28 to each of the objects 12 that is to be tracked. If the object 12 to be tracked comprises a vehicle, the radio system 16 and associated display 28 may be mounted within the cab of the vehicle to allow easy access by the vehicle operator. Unmanned vehicles (e.g., remotely controlled or autonomous vehicles) could likewise be provided with a radio system 16, thereby allowing such vehicles to be tracked by system 10 as well. Regardless of whether the mine vehicles are manned or unmanned, the radio system 16 may be provided with a vehicle interface system 98 (FIG. 3) to allow the radio system 16 to automatically operate the vehicle in certain circumstances. For example, in one embodiment, the radio system 16 may instruct the vehicle interface system 98 to stop the vehicle (e.g., by disengaging the transmission and/or applying the vehicle brake) if the system 10 determines that a collision is imminent.

Objects 12 other than vehicles can also be provided with a radio and display system 16, 28. For example, one embodiment of the invention may utilize a portable, i.e., hand-held, radio system 16 that is battery powered and can be easily carried by persons moving around on foot within the operational area 34. The display system 28 may be combined with the radio system in a manner akin to a cellular telephone or personal digital assistant. Consequently, persons on foot can be readily located and/or tracked by the system 10, even though they are not with or operating a moving vehicle or other piece of mining equipment. Generally speaking, it will be desirable to provide such a hand-held radio/display system 16, 28 to all personnel to ensure that their locations will be known at all times and to nearby personnel and equipment.

After each object 12 has been provided with a radio system 16 and associated display system 28, the various radios 16 may then be operated at step 40 so that they form or create an ad-hoc, peer-to-peer network, e.g., 42, 42′, 42″. See FIG. 10. Each of the radios 16 may be programmed so that the resulting network 42 is logically limited to radio systems 16 operating in the defined operational area 34. That is, the network 42 can be limited to only those radios 16 that happen to be located within the defined operational area 34 at any point in time. Radios 16 contained in other operational areas (e.g., 34′, 34″) will comprise parts of their respective networks (e.g., 42′, 42″), as best seen in FIG. 10.

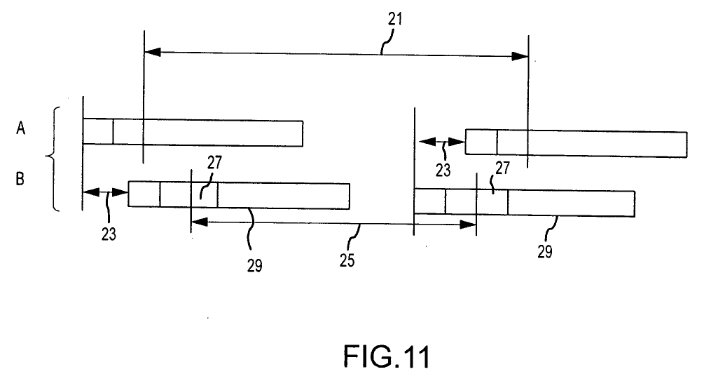

In one embodiment, a given network 42 may distinguish between radios 16 within its own network (e.g., network 42) from those contained in other networks (e.g., networks 42′ and 42″) by analyzing an appropriate network identifier tag 27 broadcast by each radio 16. See FIG. 11. Processor system 20 (FIG. 3) may generator or produce the network identifier tag 27 by correlating the current position of the radio 16 with the defined operational areas, e.g., 34, 34′, and 34,″ which may be stored in memory system 86. For example, if a given radio 16 determines (based on its current position data) that it is located within operational area 34, then that radio 16 can broadcast the appropriate network identifier tag 27 to inform the system 10 (and other radios 16) that the particular radio 16 is a part of network 42. Other radios 16 located in other operational areas, e.g., 34′, 34″, will broadcast other network identifier tags that associate such other radios 16 with the networks that correspond to the operational areas within which the radios 16 are currently located.

The broadcasting of network identifier tags 27 allows the various networks 42, 42′, 42″ to effectively limit their sizes to only those radios contained within their respective operational areas 34, 34′, 34″. That is, the various radios in a given network may be configured to ignore radios contained in other networks. Moreover, the system allows radios 16 to move from operational area to operational area (i.e., from network to network) without the need to reconfigure the system or otherwise inform the radio of its new position and associated network. That is, because the radio 16 knows its position, as well as the boundaries of the various operational areas, the radio 16 will automatically update its network identifier tag 27 without the need for additional user input.

Still referring primarily to FIG. 11, in one embodiment, the network identifier tag 27 may be one of the first pieces of information in the data set 29 broadcast by each radio 16. Because the network identifier tag 27 is one of the first pieces of information sent (and received) by the various radio systems 16 within range of the broadcasting radio, the radio systems 16 within a given network (e.g., network 42) may readily determine which radio signals 26 originated from radios outside the network 42. The radio systems 16 may then ignore signals from radios 16 confirmed to be outside the network 42.

After the network(s) (e.g., 42) have been formed by the radio systems 16, the various radio systems 16 are operated, e.g., at step 46, to determine the time-of-flight of radio signals 26 exchanged between the various radio systems 16 within a given network 42. The time-of-flight of radio signals 26 exchanged between the various radio systems 16 may then be analyzed to determine the positions of the various radio systems 16.

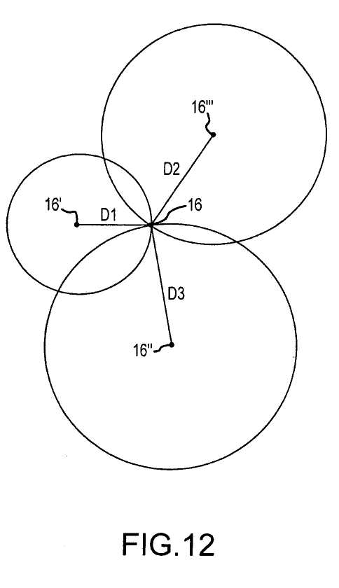

Referring now to FIG. 12, the position of a radio system 16 in two-dimensional space can be determined by determining the time required for radio signals 26 to travel between radio system 16 (the position of which is unknown) and three (3) other radios 16′, 16″, 16′″ the positions of which are known. Because radio signals 26 travel at the speed of light, the time required for radio signals 26 to travel between two radios 16 defines the distance between the radios. Thus, the position of a fourth radio 16 can be determined in two dimensional space by determining the time-of-flight, thus distances D₁, D₂, and D₃, between radio 16 and radios 16′, 16″, 16′″, when the positions of those radios are known. Similarly, the position of a radio system 16 in three-dimensional space can be determined based on the time-of-flight of radio signals from four (4) other radios, the positions of which are known.

The present invention may utilize any of a wide range of time-of-flight algorithms that are now known in the art or that may be developed in the future to determine the time required for radio signals 26 to travel between two radio systems 16. Generally speaking, the particular time-of-flight algorithm that is used should provide a high degree of positioning accuracy, such as, for example, within a few 10's of centimeters or less. In this regard it should be noted that the ultra-wideband (UWB) radio systems utilized in one embodiment provide higher accuracy than conventional, narrow-band systems when estimating the time-of-flight of a radio signal between a transmitter and receiver. The increased accuracy is due in large part to the large bandwidths associated with the UWB pulses 88. See FIG. 7. More specifically, the high bandwidth results in narrow pulses with fast rise and fall times that yield high accuracy for time of arrival measurements. For example, the UWB transmission system of the exemplary embodiment shown and described herein, the incoming UWB pulse 88 (i.e., radio signal 26) is sampled at a frequency of about 500 megahertz (MHZ), which is about ten times the sampling frequency used in conventional time-of-flight radio systems. The high sampling frequency coupled with the fast rise and fall times allows highly-accurate time of arrival measurements to be made. Of course, the ability to accurately determine the time of arrival of the radio signal is directly correlated to the distance determination, thus positional accuracy of the system.

Referring now primarily to FIG. 11, one embodiment of a time-of-flight algorithm that may be implemented by the system 10 involves a so-called two way ranging technique to determine the time-of-flight of radio signals 26 between two radios. Briefly, the two way ranging technique involves the measurement of the round trip time 21 required for the radio signal to be received by a radio 16, processed, and re-transmitted to the originating radio. The round trip time 21 therefore embodies or contains two time-of-flight times 23, as well as the processing time 25 required to process the radio signal and re-transmit it to the originating radio. Processing time 25 includes the times required to receive and transmit the signal (i.e., in the antenna and rf-sections of the transceiver 18). The one-way time-of-flight time may be calculated by subtracting from the round trip time 21 the processing time 25 and dividing by two.

Other methods for computing the time-of-flight of radio signals are also known and could be used as well. For example, alternative methods may involve one way ranging or time difference of arrival of signals. However, because algorithms for determining the time-of-flight of radio signals are well-known in the art and could be readily provided by persons having ordinary skill in the art after having become familiar with the teachings provided herein, the particular time-of-flight algorithm that may be utilized in the present invention will not be described in further detail herein.

Because the various radios 16 determine their respective positions by reference to other radios (whose positions are known), a certain minimum number of radios 16 comprising a given network 42 will need to “know” their positions before other radios 16 in the network 42 can determine their positions. In one embodiment, each network 42 may be provided with a number of radios or “nodes” at known or surveyed-in positions. Other radios 16 in the network 42 can then determine their positions based on signals received from the surveyed-in radios.

As briefly described above, the ultra-wideband radio transceiver system 18 in one embodiment may be operated in a radar mode to detect obstacles and other objects that may not be provided with a separate radio system 16, but may nevertheless pose hazards. For example, the radio system 16, when operated in the radar mode, may be used to detect the presence of berms, high-walls, or other obstacles. Obstacles detected by the radio when operated in the radar mode could be displayed on display system 28, either alone, or in conjunction with the other objects 12 provided on situational display 52.

Processor system 20 may be programmed to operate the radio transceiver system 18 in the radar mode of operation on a periodic basis (i.e., automatically, without requiring user input). Alternatively, the radio system 16 could be provided with a control switch to allow the user to manually engage the radar mode of operation when desired.

The next step 50 in the method 30 involves displaying the relative positions of at least some of the objects 12 contained within the operational area 34 on a situational display 52. See FIG. 5. In this particular example, the situational display 52 shows the various objects illustrated in the particular operational scenario illustrated in FIG. 2. As already briefly described above, the particular object 12 carrying radio system 16 and display system 28 may be displayed at the center of the situational display 52 and, in this example, corresponds to the haul truck 55 illustrated in FIG. 2. An operator viewing the situational display 52 associated with his particular vehicle or person will see his vehicle or person displayed at the center of the situational display 52 as icon 54. The particular object located at the center of the situational display 52 may be referred to herein in the alternate as the “center” object 12 to distinguish it from “surrounding” objects 12.

In the particular operational scenario illustrated in FIG. 2 (which is represented in the situational display 52 illustrated in FIG. 5), the center object 12 comprises the haul truck 55 and is represented by icon 54 located at the center of the situational display 52. If the center object is moving, the direction of motion of the center object (i.e., represented by icon 54) may be indicated by an arrow icon 56 located adjacent icon 54. As mentioned above, the processor system 20 (FIG. 3) may be programmed to calculate or derive the direction of motion, heading, and velocity of one or more of the objects 12 by analyzing the change in position data over time for the corresponding object or objects 12.

“Surrounding” objects 12 located nearby “center” object 12 (e.g., haul truck 55) may be represented with different icons depending on whether they are moving or stationary. For example, in the particular operational scenario illustrated in FIG. 5, stationary objects are represented by ring icons 58, whereas objects in motion are represented by solid circle icons 60. Alternatively, icons having other shapes and configurations may be used to designate moving and stationary objects 12. The moving objects 12, i.e., those represented by solid circle icons 60, also may be provided with pointers or line segments 62 that indicate the direction of movement of the respective moving objects 12.

The various icons presented on situational display 52 may be displayed in certain colors or with other identifying indicia depending on whether they are located within certain predetermined distances from the “center” object 12 (i.e., haul truck 55 (FIG. 2), represented by icon 54 (FIG. 5)). For example, surrounding objects 12 that are located within 25 meters (about 82 feet), of center object 12 may be displayed in a color red. Surrounding objects 12 located at a distance greater than about 100 meters (about 328 feet) from the center object 12 may be displayed in a color green. Surrounding objects 12 located at intermediate distances, e.g., between about 25 meters and about 100 meters from the center object 12 may be displayed in a color yellow. Alternatively, other distances may be used, depending on a wide variety of factors. Consequently, the present invention should not be regarded as limited to the particular distances described herein.

The situational display 52 may be also include other features and icons to convey additional information to the user or vehicle operator, as the case may be. For example, in the particular operational scenario illustrated in FIG. 5, the situational display 52 is divided into a plurality of regions (e.g., octants 64), each of which may be defined by broken lines 66. In one embodiment, broken lines 66 may also be shown on situational display 52, although this need not be the case. Moreover, each octant 64 may be provided with an “alert bar” or icon 68 that may be caused to appear on the situational display 52 when one or more objects 12 in the octant 64 is located within the predetermined distances just described.

The alert bars 68 may be displayed in the same color as that of the objects that are located within the corresponding predetermined distance. For example, the alert icon 68 may be displayed in a color yellow if one or more objects 12 in the corresponding octant 64 are located in the “yellow” distance range (e.g., between about 25 meters and about 100 meters) from the center object 12 (i.e., represented by “self” icon 54). The alert bar 68 may be displayed in a color red if one or more of the objects 12 in the corresponding octant 64 are located in the “red” distance range (e.g., less than about 25 meters) from the center object 12 (i.e., represented by “self” icon 54).

Situational display 52 may also be provided with other icons or information that may be helpful to a person observing the situational display 52. For example, in the embodiment shown and described herein, situational display 52 may be provided with a compass rose icon 70. A heading “bug” 72 may be displayed adjacent compass rose 70 to indicate the current heading of the center object 12, in this operational scenario, haul truck 55 (i.e., represented by “own equipment” icon 54 in FIG. 5).

As already mentioned, in one embodiment, each radio 16 may be operated in a radar mode from time to time in order to determine whether any obstacles are present that might pose collision or other hazards. Any such obstacles could also be presented on the situational display 52. Moreover, such obstacles may be displayed in any of the green, yellow, or red colors, depending on their distance from the center object 12.

The situational display 52 just described may be displayed on the display systems 28 associated with each of the radio systems 16, thereby allowing mine personnel, such as equipment operators, to immediately ascertain the operational situation in the immediately surrounding area. In addition, the position data from the various individual displays 28 may also be collected, integrated, and displayed on a display system 19 located at the central operations center 44, as best seen in FIG. 10.

Besides presenting the operator with a display of the surrounding area (e.g., via situational display 52), the display system 28 may be used to display other information. For example, video data (e.g., from another radio 16 or from the central operations center 44) may be presented on the display 28. Similarly, text or graphics data may also be provided on display system 28. Such text or graphics data may comprise any of a wide variety of information that may be useful to the particular operator receiving the data. Such additional data may be communicated between an among the various radio systems 16 by the communications infrastructure created by the various networks 42, 42′, 42″ and the network administrator 13, as best seen in FIG. 10.

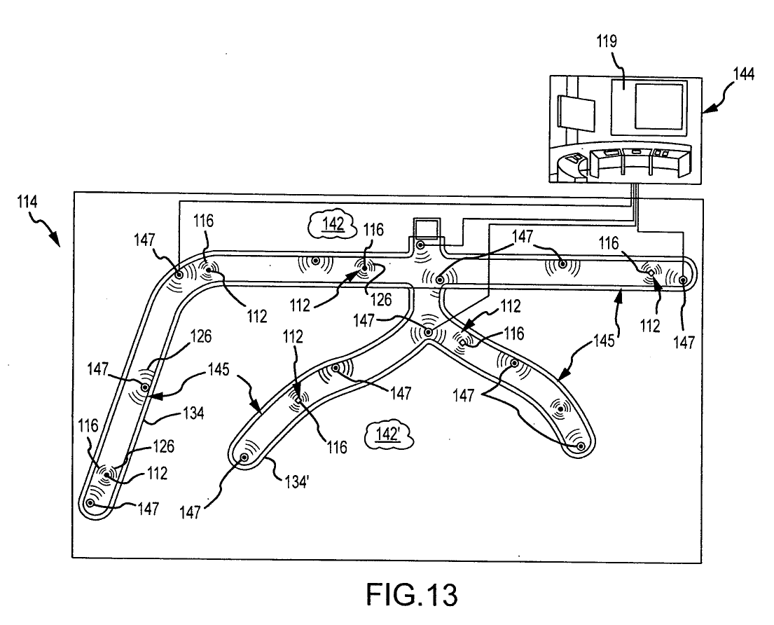

The locating and tracking system according to the present invention may be used to advantage in other types of mining environments as well. For example, in another embodiment 110, the locating and tracking system according to the present invention may be used in an underground mine 114. Referring now to FIG. 13, a notional representation of an underground mine 114 may comprise a plurality of drifts or tunnels 145 within which various objects 112, such as personnel and mining equipment (not shown), are to be located and tracked. As was the case for the first embodiment, each of the objects 112 may be provided with a radio system 116. The radio systems 116 for underground use may be substantially identical to the radio systems 16 already described. Radio signals 126 transmitted by the various radio systems 116 comprise ultra-wideband frequency pulses (e.g., pulses 88 illustrated in FIG. 6) modulated in accordance in accordance with the Spectral Keying modulation technique already described herein.

While the ultra-wideband radio signal transmission system provides for greatly enhanced signal propagation and detection characteristics in environments, such as drifts 145, that create substantial multi-path interference, it may nevertheless be advantageous in certain underground mining environments and drift configurations to also provide the system 110 with one or more network tracking synchronizing nodes 147. The network tracking synchronizing nodes 147 may serve as signal repeaters or relays to ensure the efficient and reliable propagation of the ultra-wideband radio signals 126 throughout the drifts or tunnels 145. Generally speaking, it will be desirable to located the network synchronizing nodes 147 at areas, such as tunnel bends or intersections, that may be prone to signal attenuation due to a substantial change in direction of the drift 145.

If provided, the network tracking synchronizing nodes 147 may be substantially identical to the radio systems 116, except that they need not be provided with a corresponding display system (e.g., 28), although they could be. In addition, the various network tracking synchronizing nodes 147 may be provided at fixed, “surveyed-in” locations within the drifts or tunnels 145 in the manner best seen in FIG. 13. Such surveyed-in network tracking synchronizing nodes 147 may then serve as “known position” radios required to provide position location information to radios 116 whose positions are not known.

The various radio systems 116 and network tracking synchronizing nodes 147 may be operated so that they form one or more ad-hoc, peer-to-peer networks 142, 142′ in the manner already described for the first embodiment 10. The second embodiment 110 of the locating and tracking system may also involve the use of one or more defined operational areas 134, 134′ in a manner analogous to the defined operational areas 34, 34′ and 34″ described above for the first embodiment. When used in an underground mine 114, the defined operational areas 134, 134′ may be generally co-extensive with the various drifts 145 comprising the mine 114.

The system 110 may also be provided with a central operations center 144. Position and other data from the radio systems 116 associated with the various objects 112 (e.g., mining equipment and personnel) moving within the tunnels 145, may be collected, integrated, and displayed on a suitable display system 119 provided in the central operations center 144.

The system 110 may be operated in accordance with a method that is similar to the method 30 described above for the first embodiment 10. For example, a first step in the method may involve selecting or defining one or more operational areas 134, 134′ in the mine 114 within which the locations of the various objects 112 are to be determined and tracked over time. As mentioned above, the various operational areas 134, 134′ in an underground mine 114 may be defined to be generally coextensive with the various tunnels or drifts 145, in that the tunnels or drifts 145 effectively physically define those areas in which mining personnel and equipment will be located. The next step in the process may involve providing at least one radio system 116 to each of the objects 112 that is to be tracked. The various radio systems 116 may then be operated to that they form or create an ad-hoc, peer-to-peer network 142, 142′. A separate network 142, 142′ may be associated with each defined operational area 134, 134′ in the manner already described for the first embodiment 10.

The radio systems 116 may then be operated to determine the time required for the radio signals 126 to be exchanged between various ones of the radio systems 116 in the various networks 142, 142′. The time-of-flight of such radio signals 126 is then analyzed to determine the relative positions of the radio systems 116, thus various objects 112 within the corresponding operational area (e.g., 134, 134′). The relative positions of at least some of the objects 112 within the operational area 134, 134′ may then be displayed on a display system (not shown in FIG. 13) associated with each radio system 116. More specifically, the relative position data may be provided by means of a situational display similar to the situational display 52 illustrated in FIG. 5 and described for the first embodiment 10.

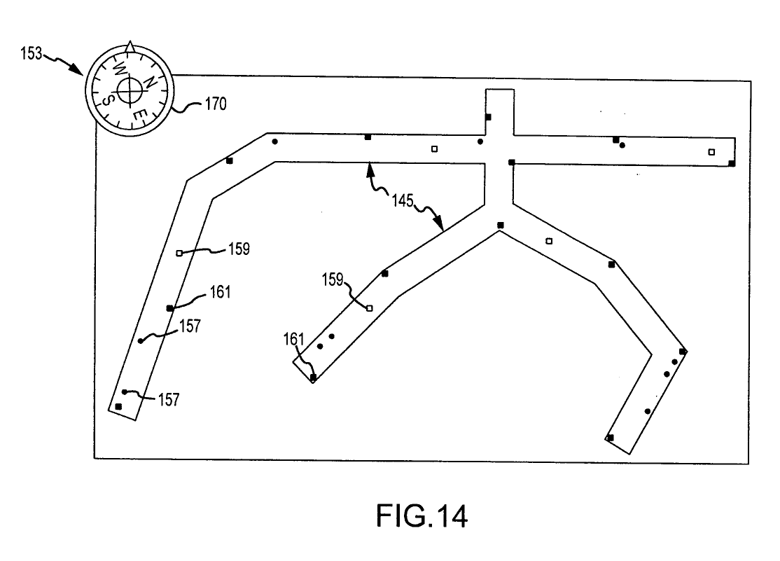

Referring now primarily to FIG. 14, and as mentioned above, the various data (such as position data) collected by the various radio systems 116 may be collected, integrated, and displayed on display system 119 provided in the central operations center 144. The system 110 may be programmed or operated to allow a mine manager or other personnel to “call-up” or caused to be displayed on display system 119 any of a wide range of data and information. For example, the system 110 may be operated to cause the situational display (e.g., similar to situational display 53) associated with any one of the radio systems 116 to be displayed on the display system 119, in the manner already described for the first embodiment 10. In addition, the system 110 may be configured or programmed to allow operations managers in the central operations center 144 to view a global situational display 153 that shows the positions of all the equipment and personnel within the various drifts or tunnels 145 that comprise the underground mine 114.

Various icons 154 may be used to represent the various objects 112 carrying or otherwise provided with radio systems 116. For example, in the embodiment illustrated in FIG. 14, mining equipment may be depicted by circular icons 157, whereas personnel on foot (i.e., carrying “hand-held” radio systems 116) may be depicted by square icons 159. Various colors may also be used to further distinguish the icons and to allow the various objects 112 to be even more readily distinguished. In the embodiment illustrated in FIG. 14, the circular icons 157 representing mining equipment may be presented in a color blue. The square icons 159 (e.g., representing personnel on foot) may be presented in a color yellow.

If the system 110 is provided with one or more network tracking synchronizing nodes 147, such nodes 147 may also be depicted by square icons 161 which may be displayed in a color red to distinguish them from the yellow square icons 159. The global situational display may also be provided with a compass rose icon 170, if desired.

Having herein set forth preferred embodiments of the present invention, it is anticipated that suitable modifications can be made thereto which will nonetheless remain within the scope of the invention. The invention shall therefore only be construed in accordance with the following claims:

1. A method for locating and tracking objects in a mine, comprising:
selecting an operational area in the mine within which the locations of a plurality of objects are to be determined and tracked over time;
providing a radio transceiver system to each of the plurality objects operating in the operational area;
providing to each of the objects operating in the operational area a display system that is operatively associated with the radio transceiver system;
operating the radio transceiver systems to form an ad-hoc, peer-to-peer network;
determining the time-of-flight of radio signals exchanged between various ones of the radio transceiver systems;
analyzing the time-of-flight of such exchanged radio signals to determine the relative positions of the various objects within the operational area; and
displaying the relative positions of the various objects within the operational area on the display system.

2. The method of claim 1, further comprising:
analyzing a plurality of time-of-flight radio signals exchanged over time between various ones of the radio transceiver systems to determine headings of the various objects within the operational area; and
displaying the headings of the various objects within the operational area on the display system.

3. The method of claim 1, further comprising:
determining whether the positions of the various objects within the operational area are within a first predetermined distance from one another; and
generating an alert signal when one or more objects are located within the first predetermined distance.

4. The method of claim 3, wherein generating an alert signal comprises generating a visual indication on the display system.

5. The method of claim 4, wherein generating the visual indication of the display system comprises highlighting a region within which one or more objects are located within the first predetermined distance.

6. The method of claim 3, wherein generating an alert signal comprises generating an aural signal.

7. The method of claim 3, further comprising stopping at least one moving object when one or more objects are located within a second predetermined distance.

8. The method of claim 7, wherein the at least one moving object comprises a manned vehicle and wherein said stopping is done automatically without driver input.

9. The method of claim 3, further comprising changing the heading of at least one moving object when one or more objects are located within a second predetermined distance.

10. The method of claim 1, wherein operating each of the radio transceiver systems to determine the time-of-flight of radio signals comprises:
generating a plurality of symbols that contain information that may be utilized to determine a time-of-flight of radio signals exchanged between two radio transceiver systems; and
transmitting said plurality of symbols by means of ultra wide band radio frequency pulses.

11. The method of claim 10, wherein said symbols are encoded through the time dependence of frequency components within said ultra wide band radio frequency pulses.

12. The method of claim 1, further comprising operating at least one of the radio transceiver systems to transmit communications data over the ad-hoc, peer-to-peer network.

13. The method of claim 12, further comprising displaying communications data received over the ad-hoc, peer-to-peer network on the display system.

14. The method of claim 1, further comprising operating at least one of the radio transceiver systems to transmit video data over the ad-hoc, peer-to-peer network.

15. The method of claim 14, further comprising displaying video data received over the ad-hoc, peer-to-peer network on the display system.

16. The method of claim 1, further comprising operating at least one of the radio transceiver systems to transmit audio data over the ad-hoc, peer-to-peer network.

17. The method of claim 1, wherein selecting an operational area in a mine within which the locations of a plurality of objects are to be determined and tracked over time comprises selecting an operational area in an open pit mine within which the locations of a plurality of objects are to be determined and tracked over time.

18. The method of claim 1, wherein selecting an operational area in a mine within which the locations of a plurality of objects are to be determined and tracked over time comprises selecting an operational area in an underground mine within which the locations of a plurality of objects are to be determined and tracked over time.

19. The method of claim 1, further comprising displaying at least some of the relative positions of the various objects within the operational area on a display system located at a remote location from the operational area.

20. The method of claim 19, further comprising collecting position data from a plurality of radio transceiver systems before displaying at least some of the relative positions of the various objects on the display system located at the remote location from the operational area.

21. The method of claim 19, further comprising integrating position data from a plurality of radio transceiver systems and displaying integrated position data on the display system located at the remote location as a global situational display.

22. A tracking system, comprising:
a plurality of objects located within an operational area of a mine within which the locations of said plurality of objects are to be determined and tracked over time;
a radio transceiver system operatively associated with individual ones of said plurality of objects, said radio transceiver system comprising:
rf transceiver means for transmitting and receiving radio signals; and
processor means operatively associated with said rf transceiver means for determining a time-of-flight required for radio signals to be exchanged between various ones of said plurality of radio transceiver systems and for determining locations of various ones of said plurality of radio transceiver systems based on the time-of-flight of exchanged radio signals; and
a display system operatively associated with at least some of said plurality of radio transceiver systems, said display system being responsive to signals from said radio transceiver system, said display system displaying the relative positions of the various objects within the mine.

23. The tracking system of claim 22, wherein said processor means analyzes a plurality of time-of-flight radio signals exchanged over time between various ones of said radio transceiver systems and determines headings of the various objects within the operational area, and wherein said processor means causes the headings of the various objects within the operational area to be displayed on said display system.

24. The tracking system of claim 22, wherein said processor means determines whether the positions of the various objects within the operational area are located within a first predetermined distance from one another and causes the display system to display an alert signal when one or more objects are located within the first predetermined distance.

25. The tracking system of claim 24, wherein said processor means causes the display system to identify a region within which one or more objects are located within the first predetermined distance.

26. The tracking system of claim 24, further comprising an aural warning system operatively associated with said processor means, said processor means activating said aural warning system when one or more objects are located within the first predetermined distance.

27. The tracking system of claim 24, wherein at least one of said objects comprises a vehicle, said tracking system further comprising a vehicle interface system operatively associated with said radio frequency transceiver system and said vehicle, and wherein said processor means determines whether the positions of the various objects within the operational area are located within a second predetermined distance from one another, said processor means commanding said vehicle interface system to stop said vehicle when one or more objects are located within the second predetermined distance.

28. The tracking system of claim 22, wherein said processor means operates said plurality of radio transceiver system to form an ad-hoc, peer-to-peer network and wherein said processor means transmits communications data over the ad-hoc, peer-to-peer network.

29. The tracking system of claim 22, wherein said processor means operates said plurality of radio transceiver systems to form an ad-hoc, peer-to-peer network and wherein said processor means transmits video data over the ad-hoc, peer-to-peer network.

30. The tracking system of claim 22, wherein said processor means operates said plurality of radio transceiver systems to form an ad-hoc, peer-to-peer network and wherein said processor means transmits audio data over the ad-hoc, peer-to-peer network.

31. The tracking system of claim 22, wherein said rf transceiver means comprises an ultra wide band transmitter for producing a plurality of radio frequency pulses having durations in a range of about 100 picoseconds to about 5 nanoseconds, each of said radio frequency pulses having a fractional bandwidth that is at least about 20% of a center frequency.

32. The tracking system of claim 31, wherein said ultra wide band transmitter produces a plurality of subpulses, each of said plurality of subpulses being centered on a different frequency.

33. The tracking system of claim 21, wherein said ultra wide band transmitter produces five subpulses, each of which is centered on a different frequency.

34. The tracking system of claim 33, wherein the different frequencies corresponding to the five subpulses have center frequencies of about 3.48 GHz, 4.02 GHz, 4.56 GHz, 6.12 GHz, and 6.96 GHz.

35. The tracking system of claim 28, further comprising a network administrator system operatively associated with the ad-hoc, peer-to-peer network, said network administrator system collecting at least position data from the various radio transceiver systems forming the ad-hoc, peer-to-peer network.

36. The tracking system of claim 35, further comprising a display system operatively associated with said network administrator system, said display system displaying at least some of the relative positions of the various objects.

37. A method, comprising:
selecting an operational area in a mine within which the locations of a plurality of objects are to be determined and tracked over time;
providing to each of the objects operating in the operational area a radio transceiver system;
providing to each of the objects operating in the operational area a display system that is operatively associated with the radio transceiver system;
operating at least one of the radio transceiver systems in a radar mode to determine a relative position of an object within the operational area; and
displaying the relative position of the object within the operational area on at least one of the display systems provided to each of the objects.

38. The method of claim 37, further comprising:
operating each of the radio transceiver systems to determine the time-of-flight of radio signals exchanged between various ones of the radio transceiver systems;
analyzing the time-of-flight of such exchanged radio signals to determine the relative positions of the various objects within the operational area that have radio transceiver systems operatively associated therewith; and
displaying the relative positions of the various objects within the operational area.

39. The method of claim 37, further comprising operating a plurality of the radio transceiver systems to form an ad-hoc, peer-to-peer network.

40. The method of claim 37, further comprising displaying at least some of the relative positions of the various objects within the operational area on a display system located at a remote location from the operational area.

41. The method of claim 37, further comprising collecting position data from a plurality of radio transceiver systems before displaying at least some of the relative positions of the various objects on the display system located at the remote location from the operational area.

42. The method of claim 37, further comprising integrating position data from a plurality of radio transceiver systems and displaying integrated position data on the display system located at the remote location as a global situational display.

43. A tracking system, comprising:
a plurality of objects located within an operational area in a mine within which the locations of said plurality of mine objects are to be determined and tracked over time;
a radio transceiver system operatively associated with individual ones of said plurality of mine objects, said radio transceiver system comprising:
rf transceiver means for transmitting and receiving radio signals;
processor means operatively associated with said rf transceiver means for operating said rf transceiver means in a radar mode to determine locations of objects in the operational area by means of radar, and for causing a plurality of said radio transceiver systems to form an ad-hoc, peer-to-peer network; and
a display system operatively associated with at least some of said plurality of radio transceiver systems, said display system being responsive to signals from said radio transceiver system, said display system displaying the relative positions of objects located within the operational area.

44. The mine object tracking system of claim 43, wherein said processor means operates said rf transceiver means to determine a time-of-flight required for radio signals to be exchanged between various ones of said plurality of radio transceiver systems and determines locations of various ones of said plurality of radio transceiver systems based on the time-of-flight of exchanged radio signals, and wherein said processor means operates said display system to display the relative positions of objects having radio transceiver systems.
